(19) United States
(12) Patent Application Publication
(10) Pub. No.: US 2026/0169930 A1
(43) Pub. Date: Jun. 18, 2026

(54) Publish-Subscribe Interface

(71) Applicant: MELLANOX TECHNOLOGIES, LTD., Yokneam (IL)

(72) Inventors: Gal Shalom, Givat-Avni (IL); Omri Kahalon, Sylvan Lake (CA); Aviad Shaul Yehezkel, Yokneam Ilit (IL); Dimitrios Syrivelis, Volos (GR)

(21) Appl. No.: 19/001,444

(22) Filed: Dec. 25, 2024

(30) Foreign Application Priority Data
Dec. 18, 2024 (GR) 20240100899

(51) Int. Cl. G06F 13/10; G06F 15/173

(52) U.S. Cl. CPC G06F 13/102; G06F 15/17331

(57) ABSTRACT

In one embodiment, a data processing unit (DPU) includes a host interface to receive a generic publish-subscribe (Pub/Sub) call from a host device, at least one processing core to execute an orchestration function to select a specific pub/sub service based on the generic pub/sub call, and a translation layer to translate the generic pub/sub call to a specific pub/sub call compatible with the selected specific pub/sub service, and a forwarding interface to provide the translated specific pub/sub call to the selected specific pub/sub service.

### FIELD OF THE DISCLOSURE

The present disclosure relates to computer systems, and in particular, but not exclusively to, publish-subscribe systems.

### BACKGROUND

Publish-subscribe (pub/sub) systems have become an integral part of modern distributed computing architectures. These systems provide a messaging paradigm that allows for decoupled communication between publishers, which generate and send messages, and subscribers, which receive and process messages of interest. pub/sub systems are widely used in various applications, including real-time data processing, event-driven architectures, and Internet of Things (IoT) scenarios.

In a typical pub/sub system, publishers and subscribers are unaware of each other's existence. Instead, they interact through intermediary components, often referred to as brokers. Publishers send messages on specific topics, while subscribers express interest in one or more topics. The broker is responsible for receiving messages from publishers, managing subscriptions, and delivering messages to the appropriate subscribers.

### SUMMARY

There is provided in accordance with an embodiment of the present disclosure, a data processing unit (DPU) including a host interface to receive a generic publish subscribe (Pub/Sub) call from a host device, at least one processing core to execute an orchestration function to select a specific pub/sub service based on the generic pub/sub call, and a translation layer to translate the generic pub/sub call to a specific pub/sub call compatible with the selected specific pub/sub service, and a forwarding interface to provide the translated specific pub/sub call to the selected specific pub/sub service.

Further in accordance with an embodiment of the present disclosure the specific pub/sub service includes at least one of a broker-based pub/sub service or a brokerless pub/sub service.

Still further in accordance with an embodiment of the present disclosure the generic pub/sub call includes a publication message or a subscription request.

Additionally in accordance with an embodiment of the present disclosure the orchestration function is to maintain a mapping between topics and different pub/sub services.

Moreover, in accordance with an embodiment of the present disclosure the orchestration function is to select the specific pub/sub service based on a topic associated with the generic pub/sub call.

Further in accordance with an embodiment of the present disclosure the at least one processing core is to execute para virtualized pub/sub backends to interface with a para virtualized pub/sub driver frontend running on the host device.

Still further in accordance with an embodiment of the present disclosure the para virtualized pub/sub backends include multiple backend translation functions of the translation layer, each backend translation function corresponding to a different pub/sub service.

Additionally in accordance with an embodiment of the present disclosure the generic pub/sub call is based on a Remote Direct Memory Operation (RDMO) pub/sub command.

Moreover, in accordance with an embodiment of the present disclosure the orchestration function is to receive an RDMO notification from the host device, read the RDMO pub/sub command from a work queue stored in host memory responsively to receiving the RDMO notification, and derive the generic pub/sub call from the read RDMO pub/sub command.

Further in accordance with an embodiment of the present disclosure the translation layer includes multiple translation functions to translate generic pub/sub calls to specific pub/sub calls compatible with respective pub/sub services.

Still further, in accordance with an embodiment of the present disclosure the at least one processing core is to execute a security function to filter or block pub/sub calls based on predefined criteria without notifying the host device.

There is also provided in accordance with another embodiment of the present disclosure, a system including a host device to generate a generic publish subscribe (Pub/Sub) call, and a data processing unit (DPU) coupled to the host device, the DPU including a host interface to receive the generic pub/sub call from the host, at least one processing core to execute an orchestration function to select a specific pub/sub service based on the generic pub/sub call, and a translation layer to translate the generic pub/sub call to a specific pub/sub call compatible with the selected specific pub/sub service, and a forwarding interface to provide the translated specific pub/sub call to the selected specific pub/sub service.

Additionally in accordance with an embodiment of the present disclosure the specific pub/sub service includes at least one of a broker-based pub/sub service or a brokerless pub/sub service.

Moreover, in accordance with an embodiment of the present disclosure the generic pub/sub call includes a publication message or a subscription request.

Further in accordance with an embodiment of the present disclosure the orchestration function is to maintain a mapping between topics and different pub/sub services.

Still further in accordance with an embodiment of the present disclosure the orchestration function is to select the specific pub/sub service based on a topic associated with the generic pub/sub call.

Additionally in accordance with an embodiment of the present disclosure the host is to execute a para virtualized pub/sub driver frontend, and the at least one processing core of the DPU is to execute para virtualized pub/sub backends to interface with the para virtualized pub/sub driver frontend running on the host device.

Moreover, in accordance with an embodiment of the present disclosure the para virtualized pub/sub backends include multiple backend translation functions of the translation layer, each backend translation function corresponding to a different pub/sub service.

Further in accordance with an embodiment of the present disclosure the generic pub/sub call is included in a Remote Direct Memory Operation (RDMO) pub/sub command.

Still further in accordance with an embodiment of the present disclosure the host device is to generate the RDMO pub/sub command, write the RDMO pub/sub command to a work queue stored in host memory, and send an RDMO notification to the DPU notifying the DPU that the RDMO pub/sub command is in the work queue, and the orchestration function is to receive the RDMO notification from the host device, read the RDMO pub/sub command from the work queue responsively to receiving the RDMO notification, and derive the generic pub/sub call from the read RDMO pub/sub command.

Additionally in accordance with an embodiment of the present disclosure the translation layer includes multiple translation functions to translate generic pub/sub calls to specific pub/sub calls compatible with respective pub/sub services.

Moreover, in accordance with an embodiment of the present disclosure the at least one processing core is to execute a security function to filter or block pub/sub calls based on predefined criteria without notifying the host device.

There is also provided in accordance with still another embodiment of the present disclosure a method, including receiving a generic publish subscribe (Pub/Sub) call from a host device, selecting a specific pub/sub service based on the generic pub/sub call, translating the generic pub/sub call to a specific pub/sub call compatible with the selected specific pub/sub service, and providing the translated specific pub/sub call to the selected specific pub/sub service.

### BRIEF DESCRIPTION OF THE DRAWINGS

The present disclosure will be understood from the following detailed description, taken in conjunction with the drawings in which:

FIG. 1 is a partly pictorial, partly block diagram view of a pub/sub system with multiple brokers and brokerless services constructed and operative in accordance with an embodiment of the present disclosure;

FIG. 2 is a block diagram view of a para-virtualized pub/sub sub-system for use in the system of FIG. 1;

FIGS. 3a and 3b are flow charts including steps in methods of operation of the para-virtualized pub/sub sub-system of FIG. 2;

FIG. 4 is a block diagram view of a RDMO pub/sub sub-system for use in the system of FIG. 1;

FIGS. 5a and 5b are flow charts including steps in methods of operation of the RDMO pub/sub sub-system of FIG. 4; and

FIG. 6 is a block diagram that schematically illustrates a computing system, e.g., a data center or a high-performance computing (HPC) cluster, in accordance with an embodiment of the present disclosure.

### DESCRIPTION OF EXAMPLE EMBODIMENTS

### Overview of Example Embodiments

As the adoption of pub/sub systems has grown, various implementations and services have emerged, each with its own set of APIs, protocols, and features. This diversity has led to challenges in interoperability and portability of applications across different pub/sub environments. Developers often find themselves tightly coupled to specific pub/sub implementations, making it difficult to switch between services or leverage multiple pub/sub systems simultaneously.

The increasing complexity of distributed systems has also highlighted the need for more flexible and efficient pub/sub architectures. Traditional broker-based systems may introduce latency and scalability concerns in certain scenarios, leading to the development of brokerless pub/sub implementations. However, the coexistence of broker-based and brokerless systems further complicates the landscape for application developers and system architects.

As organizations adopt multi-cloud strategies and hybrid infrastructures, the ability to seamlessly integrate and manage pub/sub communications across diverse environments becomes important. This integration challenge extends beyond just connecting different pub/sub systems; it also involves addressing security, performance, and operational concerns that arise in heterogeneous deployments.

The evolution of hardware acceleration technologies, such as data processing units (DPUs), presents new opportunities for optimizing pub/sub systems. These specialized processors offer the potential to offload and accelerate pub/sub operations, potentially reducing latency and improving overall system efficiency. However, leveraging these capabilities in a way that maintains the abstraction and flexibility of pub/sub systems remains an area of active research and development.

As the field of pub/sub systems continues to evolve, there is a growing need for solutions that can bridge the gap between different implementations, provide greater flexibility in deployment options, and take advantage of emerging hardware technologies. Addressing these challenges could lead to more robust, scalable, and efficient pub/sub architectures that better serve the needs of modern distributed applications.

Therefore, embodiments of the present disclosure address at least some of these challenges by providing a publish-subscribe (pub/sub) orchestration and translation system implemented using a data processing unit (DPU). This system addresses the challenges of interoperability and flexibility in pub/sub communications across diverse environments. The DPU serves as an intermediary layer between host device(s) generating generic pub/sub calls and various specific pub/sub services.

Generic pub/sub calls may be generated by a pub/sub application running on a host device. The pub/sub application may be a publish application and/or a subscribe application. The pub/sub call may be a publish call or a subscribe call. Similarly, any reference herein to pub/sub may be understood as a reference to publish and/or subscribe.

The DPU has a host interface that receives generic pub/sub calls from one or more host devices, an orchestration function that selects the appropriate specific pub/sub service based on the received general pub/sub call, a translation layer that converts the generic pub/sub calls into specific pub/sub calls compatible with the selected service, and a forwarding interface that transmits the translated calls to the chosen pub/sub service (e.g., broker).

The orchestration function may maintain mappings between topics and services, allowing it to select a suitable pub/sub service for each call. The system supports both broker-based and brokerless pub/sub services, enhancing its flexibility and applicability across different architectures.

To facilitate efficient communication from the host device(s) to the DPU, the host device(s) may run a para-virtualized pub/sub driver frontend that interfaces with para-virtualized backends running on the DPU. The backends may include multiple translation functions, each corresponding to a different pub/sub service (e.g., broker), allowing for easy updates and maintenance of the system.

The disclosure also accommodates Remote Direct Memory Operation (RDMO) pub/sub commands, potentially improving performance in suitable scenarios. When working with RDMO pub/sub commands, the orchestration function can receive RDMO pub/sub notifications from the host device, read RDMO pub/sub commands from a work queue in host memory, and derive generic pub/sub calls from these commands.

Additionally, the DPU may incorporate a security function to filter or block pub/sub calls based on predefined criteria, enhancing the system's security without notifying the host device.

This comprehensive approach allows use of a standardized pub/sub interface while the DPU manages the complexities of interfacing with diverse pub/sub implementations, thereby enhancing interoperability, portability, and scalability across different pub/sub environments, including multi-cloud and hybrid infrastructures.

### System Description

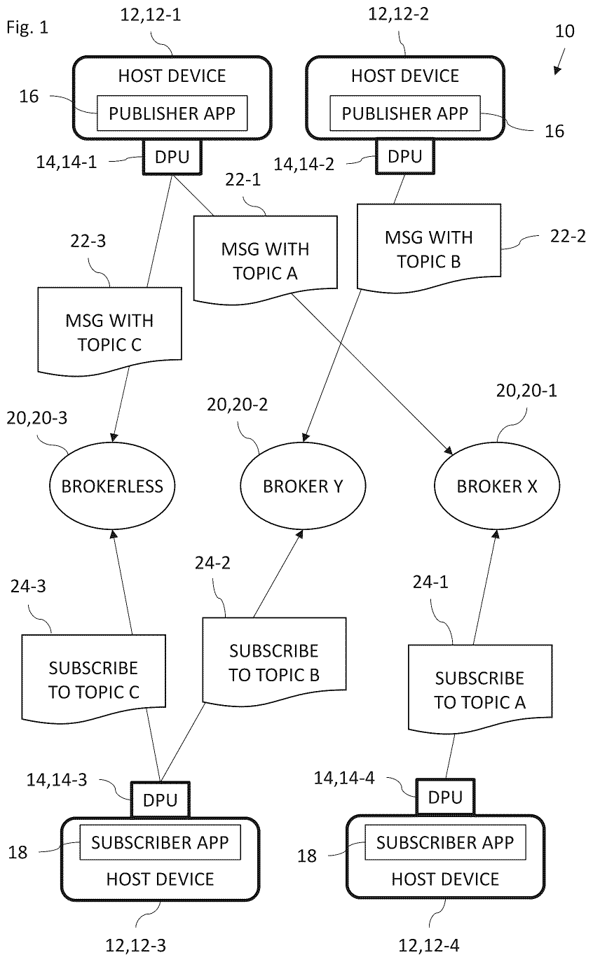

Reference is now made to FIG. 1, which is a partly pictorial, partly block diagram view of a pub/sub system 10 with multiple brokers 20 and brokerless 20-3 services constructed and operative in accordance with an embodiment of the present disclosure. FIG. 1 illustrates that publish-subscribe (pub/sub) system 10 includes multiple host devices 12 and data processing units (DPUs) 14 interacting with both broker-based and brokerless pub/sub services.

A Data Processing Unit (DPU) is a specialized processor designed to handle data-centric tasks, offloading and accelerating data processing operations from the central processing unit (CPU). DPUs are typically used in high-performance computing environments, data centers, and network infrastructure to improve efficiency and performance. They are equipped with multiple processing cores, memory, and network interfaces, enabling them to manage tasks such as data movement, security, and network traffic management. In the context of publish-subscribe (pub/sub) systems, a DPU can serve as an intermediary layer between host devices generating generic pub/sub calls and various specific pub/sub services, handling the complexities of interfacing with diverse pub/sub implementations.

A broker service in the context of publish-subscribe (Pub/Sub) systems refers to an intermediary component that facilitates communication between publishers and subscribers. In a broker-based pub/sub system, publishers send messages to the broker, which then routes these messages to the appropriate subscribers based on their subscriptions. The broker manages the distribution of messages, ensuring that each subscriber receives the messages they are interested in. This approach decouples publishers and subscribers, allowing them to operate independently without needing to be aware of each other's existence. The broker service handles tasks such as message filtering, delivery, and persistence, providing a centralized point for managing pub/sub communications.

A brokerless service in the context of publish-subscribe (Pub/Sub) systems refers to a pub/sub implementation that operates without the use of intermediary components known as brokers. In a brokerless pub/sub system, publishers send messages directly to subscribers without routing through a central broker, which can reduce latency and improve scalability by eliminating the need for an intermediary to manage message distribution. This approach allows for more direct and efficient communication between publishers and subscribers.

The pub/sub system 10 comprises several host devices 12 (namely host device 12-1, 12-2, 12-3, and 12-4). Host devices 12-1 and 12-2 are equipped with publisher applications 16, which generate messages on specific topics. These messages are then sent to their respective DPUs 14-1, 14-2 for further processing.

Host device 12-1, running a publisher application 16, generates a message 22-1 on topic A. This message 22-1 is sent to DPU 14-1, which processes the message 22-1 and forwards it to broker X (ref. num. 20-1). Similarly, host device 12-2, also running publisher application 16, generates a message 22-2 on topic B. This message 22-2 is sent to DPU 14-2, which processes the message 22-2 and forwards it to broker Y (ref. num. 20-2). Additionally, another message 22-3 on topic C is generated by the publisher application 16 of host device 12-1 and sent to a brokerless service 20-3.

On the subscriber side, host devices 12-3 and 12-4 are equipped with subscriber applications 18. These applications 18 express interest in specific topics through subscription requests 24. Host device 12-3, running a subscriber application 18, subscribes to topic C using request 24-3. This subscription request 24-3 is processed by DPU 14-3, and delivered to the brokerless service 20-3, which ensures that messages on topic C are delivered to the subscriber application running on host device 12-3. Additionally, there is a subscription request 24-2 to topic B. This subscription request 24-2 is processed by DPU 14-3, and delivered to broker Y (ref. num. 20-2), which ensures that messages on topic B are delivered to the subscriber application running on host device 12-3.

Host device 12-4, also running subscriber application 18, subscribes with request 24-1 to topic A. This subscription request 24-1 is processed by DPU 14-4, and sent to broker X (ref. num. 24-1), which ensures that messages on topic A are delivered to the subscriber application running on host device 12-4.

The pub/sub system 10 supports both broker-based and brokerless pub/sub services, providing a flexible and efficient architecture for managing pub/sub communications across diverse environments. By leveraging the capabilities of the DPUs 14 the system can handle the complexities of interfacing with various pub/sub services, ensuring seamless interoperability and scalability.

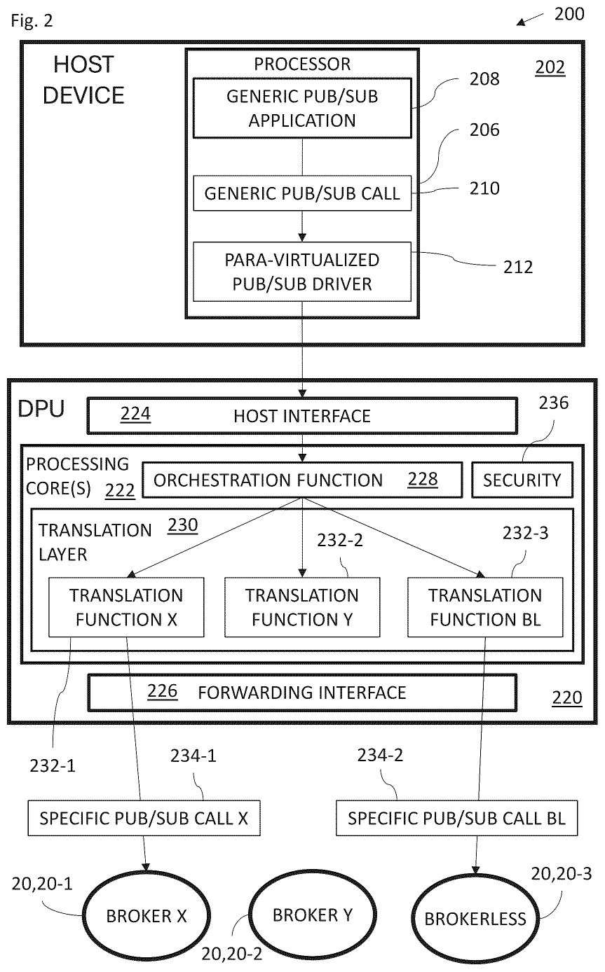

Reference is now made to FIG. 2, which is a block diagram view of a para-virtualized pub/sub sub-system 200 for use in the system 10 of FIG. 1.

The para-virtualized pub/sub sub-system 200 operates within the pub/sub system 10, facilitating communication between one or more host devices and various pub/sub services. The para-virtualized pub/sub sub-system 200 includes several components that work together to manage and translate pub/sub calls.

Para-virtualized refers to a virtualization technique where the guest operating system is aware of the virtualization environment and interacts with the hypervisor through a specialized interface. This approach allows for more efficient communication and resource management between the guest OS and the hypervisor, as the guest OS can make optimized calls to the hypervisor, reducing the overhead typically associated with full virtualization. In the context of the present disclosure, a para-virtualized pub/sub driver frontend running on the host interfaces with para-virtualized backends running on the DPU, facilitating efficient communication and translation of pub/sub calls.

Sub-system 200 includes a host device 202 that includes a processor 206. The processor 206 is configured to execute a generic pub/sub application 208, which is configured to generate a generic pub/sub call 210. The generic pub/sub application 208 can be either a publisher or a subscriber application, depending on the specific use case. The generic pub/sub call 210 may include a publication message or a subscription request.

The processor 206 is configured to execute a para-virtualized pub/sub driver 212, which is configured to receive the generic pub/sub call 210 from the generic pub/sub application 208 running on the host device 202. The para-virtualized pub/sub driver 212 acts as a frontend driver, facilitating communication between the host device 202 and a DPU 220.

The system 200 also includes DPU 220, which is coupled to the host device 402 via host interface 224. The DPU 220 comprises several sub-components, including one or more processing cores 222, host interface 224, and a forwarding interface 226. The host interface 224 is configured to receive the generic pub/sub call 210 from the para-virtualized pub/sub driver 212 running on the host device 202. The processing cores(s) 222 is configured to execute an orchestration function 228 and a translation layer 230.

The orchestration function 228 within the DPU 220 is configured to select a specific pub/sub service based on the received generic pub/sub call 210. The specific pub-sub service may be broker-based pub/sub services, such as broker X (ref. num. 20-1) and broker Y (ref. num. 20-2), or a brokerless pub/sub service 20-3. The orchestration function 228 is configured to maintain a mapping between topics and different pub/sub services (i.e., which services manage which topics), allowing the selection of a suitable pub/sub service for each call. The orchestration function 228 is configured to select between broker-based pub/sub services, such as broker X (ref. num. 20-1) and broker Y (ref. num. 20-2), and brokerless pub/sub services 20-3.

The translation layer 230 within the DPU 220 is configured to translate the generic pub/sub call 210 to a specific pub/sub call compatible with the selected specific pub/sub service. The translation layer 230 includes multiple translation functions, such as translation function X (ref. num. 232-1), translation function Y (ref. num. 232-2), and Translation Function BL (ref. num. 232-3), where BL stands for brokerless. Each translation function corresponds to a different pub/sub service, ensuring that the translated call is compatible with the selected pub/sub service.

The forwarding interface 226 within the DPU 220 is configured to provide the translated Specific pub/sub call to the selected specific pub/sub service. The forwarding interface 226 ensures that the translated call is transmitted to the appropriate pub/sub service, whether the service is a broker-based service or a brokerless service.

The para-virtualized pub/sub sub-system 200 supports both broker-based and brokerless pub/sub services, enhancing the flexibility and applicability across different architectures. The system 200 can handle publication messages and subscription requests, ensuring seamless interoperability and scalability across diverse pub/sub environments.

The para-virtualized pub/sub sub-system 200 also includes a security function 236 within the DPU 220. The security function 236 is configured to filter or block pub/sub calls based on predefined criteria without notifying the host device 202. This enhances the system's security by preventing unauthorized or malicious pub/sub calls from being processed.

The para-virtualized pub/sub sub-system 200 leverages para-virtualized backends to interface with the para-virtualized pub/sub driver 212 frontend running on the host device 202 where the host device 202 views the DPU 220 as a virtual pub/sub device. These backends include multiple backend translation functions of the translation layer 230, each corresponding to a different pub/sub service. This configuration allows for easy updates and maintenance of the system, ensuring that the system can adapt to changes in pub/sub services and protocols.

The para-virtualized pub/sub sub-System 200 provides a comprehensive solution for managing pub/sub communications across diverse environments. By leveraging the capabilities of the DPU 220, the system can handle the complexities of interfacing with various pub/sub services, ensuring seamless interoperability, portability, and scalability.

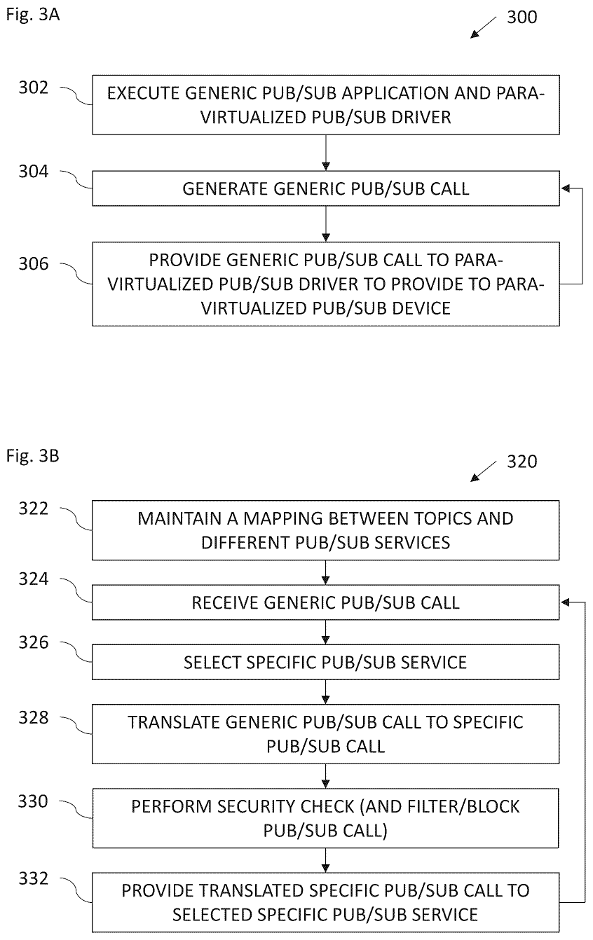

Reference is now made to FIGS. 3A and 3B, which are flow charts 300, 320 including steps in methods of operation of the para-virtualized pub/sub sub-system of FIG. 2. FIGS. 3A and 3B show an embodiment of methods for operating a para-virtualized publish-subscribe (pub/sub) sub-system. The methods 300 and 320 can be implemented by the para-virtualized pub/sub sub-system 200 described in FIG. 2.

At step 302 of FIG. 3A, the processor 206 executes generic pub/sub application 208 and a para-virtualized pub/sub driver 212 on host device 202. The generic pub/sub application 208 generates generic pub/sub calls, while the para-virtualized pub/sub driver 212 facilitates communication between the host device 202 and DPU 220.

At step 304, the generic pub/sub application 208 generates generic pub/sub call 210. This call can be either a publication message or a subscription request, depending on the specific use case of the generic pub/sub application 208.

At step 306, the para-virtualized pub/sub driver 212 provides the generic pub/sub call 210 to the host interface 224 of DPU 220 for further processing.

At step 322 of FIG. 3B, the orchestration function 228 maintains a mapping between topics and different pub/sub services. This mapping allows the orchestration function 228 to select a suitable pub/sub service for each generic pub/sub call 210 based on the associated topic.

At step 324, the host interface 224 receives the generic pub/sub call 210 from the para-virtualized pub/sub driver 212.

At step 326, the orchestration function 228 selects a specific pub/sub service based on the received generic pub/sub call 210. The selection is made using the mapping maintained in step 322, ensuring that the call is directed to the appropriate pub/sub service.

At step 328, the relevant translation function of the translation layer 230 translates the generic pub/sub call 210 to a specific pub/sub call compatible with the selected specific pub/sub service. The translation layer 230 includes multiple translation functions, such as translation function X (ref. num. 232-1), translation function Y (ref. num. 232-2), and translation function BL (ref. num. 232-3).

At step 330, the security function 236 performs a security check of the specific pub/sub call and filters or blocks the specific pub/sub call if one or more security criteria are not met, e.g., without notifying the host device. If the specific pub/sub call is not blocked, the method continues with step 332. The security check may include enforcing privileged access to some topics for publish or subscribe calls, enforcing privileged access to specific messages which include sensitive data, anonymizing sensitive data in messages or preventing unauthorized or malicious pub/sub calls from being processed.

At step 332, the forwarding interface 226 provides the translated specific pub/sub call to the selected specific pub/sub service (i.e., the selected broker or brokerless). The forwarding interface 226 ensures that the translated call is transmitted to the appropriate pub/sub service for further processing, whether it is broker X, broker Y, or brokerless.

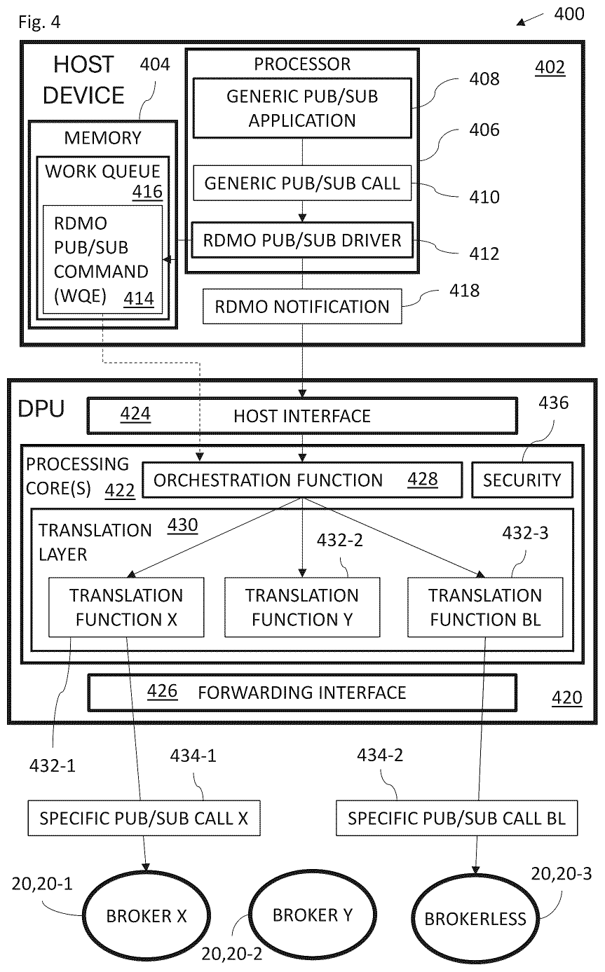

Reference is now made to FIG. 4, which is a block diagram view of a RDMO pub/sub sub-system 400 for use in the system of FIG. 1. The RDMO pub/sub sub-System 400 operates within the pub/sub system 10, facilitating communication between one or more host devices and various pub/sub services. The RDMO pub/sub sub-system 400 includes several components that work together to manage and translate pub/sub calls.

The system 400 includes a host device 402, which includes a processor 406 configured to execute a generic pub/sub application 408, which generates these generic pub/sub calls including a generic pub-sub call 410. The generic pub/sub application 408 can be either a publisher or a subscriber application, depending on the specific use case. The generic pub/sub call 410 may include a publication message or a subscription request. The host device 402 also includes a memory 404.

The processor 406 is configured to execute an RDMO pub/sub driver 412. RDMO pub/sub driver 412 is configured to generate an RDMO pub/sub command 414 from the and generic pub/sub call 410 and add RDMO pub/sub command 414 as a work-queue entry (WQE) to a work queue 416, which is stored in memory 404 of the host device 402. The RDMO pub/sub command 414 includes the generic pub/sub call 410 or a link to the generic pub/sub call 410.

The RDMO pub/sub driver 412 is configured to generates an RDMO notification 418 and provide the RDMO notification 418 to an orchestration function 428 via a host interface 424 of a DPU 420 to notify the orchestration function 428 of the RDMO pub/sub command 414 waiting in the work queue 416.

The system 400 also includes DPU 420, which is coupled to host device 402 via host interface 424. The DPU 420 comprises several sub-components, including one or more processing core(s) 422, host interface 424, and a forwarding interface 426. The host interface 424 is configured to receive the RDMO notification 418 from the RDMO pub/sub driver 412 and provide it to orchestration function 428. The processing core(s) 422 are configured to execute orchestration Function 428 and a translation layer 430.

The orchestration function 428 is configured to receive the RDMO notification 418 (from the host device 402) and retrieve the RDMO pub/sub command 414 from the work queue 416 in response to receiving the RDMO notification 418, extract the generic pub/sub call 410 from the RDMO pub/sub command 414, and select a specific pub/sub service based on the extracted generic pub/sub call 410. The specific pub-sub service may be broker-based pub/sub services, such as broker X (ref. num. 20-1) and broker Y (ref. num. 20-2), or a brokerless pub/sub service 20-3.

The orchestration function 428 maintains a mapping between topics and different pub/sub services, allowing the selection of a suitable pub/sub service for each call. In the example of FIG. 4, the orchestration function 428 can select between broker-based pub/sub services, such as broker X (ref. num. 20-1) and broker Y (ref. num. 20-2), and brokerless pub/sub services 20-3.

The translation layer 430 within the DPU 420 translates the generic pub/sub call 410 to a specific pub/sub call compatible with the selected specific pub/sub service. The translation layer 430 includes multiple translation functions, such as translation function X (ref. num. 432-1), translation function Y (ref. num. 432-2), and translation function BL (ref. num. 432-3). Each translation function corresponds to a different pub/sub service, ensuring that the translated pub/sub call is compatible with the selected service.

The forwarding interface 426 is configured to provide the translated specific pub/sub call to the selected specific pub/sub service. The forwarding interface 426 ensures that the translated call is transmitted to the appropriate pub/sub service, whether the service is a broker-based service or a brokerless service.

The RDMO pub/sub sub-system 400 supports both broker-based and brokerless pub/sub services, enhancing the flexibility and applicability across different architectures. The system can handle publication messages and subscription requests, ensuring seamless interoperability and scalability across diverse pub/sub environments.

The RDMO pub/sub sub-system 400 also includes a security function 436 within the DPU 420. The security function 436 is configured to filter or block pub/sub calls based on predefined criteria without notifying the host device 402. This enhances the system's security by preventing unauthorized or malicious pub/sub calls from being processed.

The RDMO pub/sub sub-system 400 provides a comprehensive solution for managing pub/sub communications across diverse environments. By leveraging the capabilities of the DPU 420, the system can handle the complexities of interfacing with various pub/sub services, ensuring seamless interoperability, portability, and scalability.

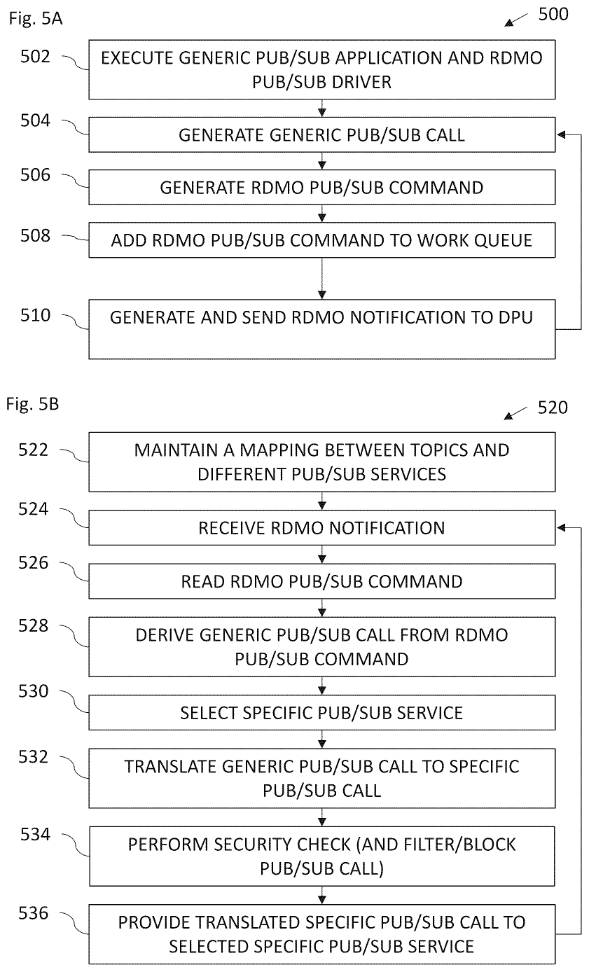

Reference is now made to FIGS. 5A and 5B, which are flow charts 500, 520 including steps in methods of operation of the RDMO pub/sub sub-system 400 of FIG. 4. In FIG. 5A, the flowchart 500 begins with step 502, where the processor 406 executes generic pub/sub application 408 and RDMO pub/sub driver 412 on the host device 402. The generic pub/sub application 408 generates generic pub/sub calls 410, while the RDMO pub/sub driver 412 facilitates communication between the host device 402 and DPU 420.

At step 504, the generic pub/sub application 408 generates generic pub/sub call 410. This call can be either a publication message or a subscription request, depending on the specific use case of the generic pub/sub application 408.

At step 506, the RDMO pub/sub driver 412 generates RDMO pub/sub command 414. At step 508, the RDMO pub/sub driver 412 adds the RDMO pub/sub command 414 to the work queue 416 as a WQE.

At step 510, the RDMO pub/sub driver 412 generates an RDMO notification 418, which is provided to orchestration function 428 via the host interface 424. This notification 418 informs the orchestration function 428 of the RDMO pub/sub command 414 waiting in the work queue 416.

In FIG. 5B, the flowchart 520 begins with step 522, where orchestration function 428 maintains a mapping between topics and different pub/sub services. This mapping allows the system to select a suitable pub/sub service for each generic pub/sub call 410 based on the associated topic.

At step 524, the host interface 424 receives the RDMO notification 418 from the RDMO pub/sub driver 412. The notification informs the orchestration function 428 of the RDMO pub/sub command 414 waiting in the work queue 416.

At step 526, the orchestration function 428 reads the RDMO pub/sub command 414 from the work queue 416. The orchestration function 428 retrieves the command 414 from the queue 416 stored in the host memory 404.

At step 528, the orchestration function 428 derives the generic pub/sub call 410 from the read RDMO pub/sub command 414. This step involves extracting information from the command 414 to generate the generic pub/sub call 410.

At step 530, the orchestration function 428 selects a specific pub/sub service based on the received generic pub/sub call 410. The selection is made using the mapping maintained in step 522, ensuring that the call is directed to the appropriate pub/sub service.

At step 532, the translation layer 430 translates the generic pub/sub call 410 to a specific pub/sub call compatible with the selected specific pub/sub service. The Translation Layer 430 includes multiple Translation Functions, such as Translation Function X, Translation Function Y, and Translation Function BL.

At step 534, the security function 436 performs a security check of the specific pub/sub call and filters or blocks the specific pub/sub call if one or more security criteria are not met, e.g., without notifying the host device. If the specific pub/sub call is not blocked, the method continues with step 536. The security check may include enforcing privileged access to some topics for publish or subscribe calls, enforcing privileged access to specific messages which include sensitive data, anonymizing sensitive data in messages or preventing unauthorized or malicious pub/sub calls from being processed.

At step 536, the forwarding interface 426 provides the translated specific pub/sub call to the selected specific pub/sub service. The Forwarding Interface 426 ensures that the translated call is transmitted to the appropriate pub/sub service for further processing, whether it is broker X, broker, or brokerless.

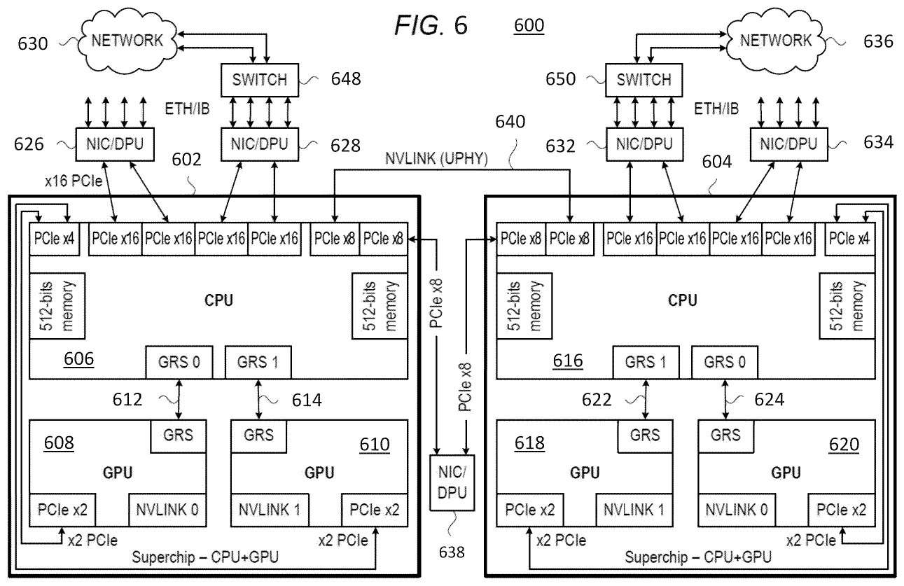

Reference is now made to FIG. 6, which is a block diagram that schematically illustrates a computing system 600, e.g., a data center or a High-Performance Computing (HPC) cluster, in accordance with an embodiment of the present disclosure. The network devices 14, 220, 420 described herein above with reference to FIGS. 1-5 may be included in system 600 as one of the DPUs of system 600. The host devices 12, 202, 402 described herein above with reference to FIGS. 1-5 may be included in system 600 as one of the processing devices 602, 604.

System 600 comprises a plurality of subsystems, e.g. multiple processing devices coupled to each other, multiple network devices, and multiple networks, according to at least one embodiment. Computing system 600 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 600 and to one or more external networks 630, 636. In the present example, system 600 comprises a packet switch 648 that connects NIC/DPU 628 to network 630, and a packet switch 650 that connects NIC/DPU 632 to network 636.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 600 can include one or more CPUs and one or more GPUs.

FIG. 6 also demonstrates an example architecture of a multi-GPU architecture. As illustrated in the figure, computing system 600 includes a processing device 602 with a multi-GPU architecture. In particular, processing device 602 may be a system-on-chip and includes multiple subsystems such as a CPU 606, a GPU 608, and a GPU 610. CPU 606 can be coupled to GPU 608 via a die-to-die (D2D) or chip-to-chip (C2C) interconnect 612, such as a Ground-Referenced Signaling interconnect (GRS interconnect). CPU 606 can be coupled to GPU 610 via a D2D or C2C interconnect 614. CPU 606 can also couple to GPU 608 and GPU 610 via PCIe interconnects.

CPU 606 can be coupled to one or more NICs or DPUs, which are coupled to one or more networks. For example, as illustrated in FIG. 6, CPU 606 is coupled to a first NIC/DPU 626, which is coupled to a network 630. CPU 606 is also coupled to a second NIC/DPU 628, which is coupled to network 630 via switch 648. NIC/DPU 626 and NIC/DPU 628 can be coupled to network 630 over Ethernet (ETH), NVLINK or InfiniBand (IB) connections, for example.

Computing system 600 also includes a processing device 604 with a multi-GPU architecture. In particular, processing device 604 includes multiple subsystems including a CPU 616, a GPU 618, and a GPU 620. CPU 616 can be coupled to GPU 618 via a D2D or C2C interconnect 622. CPU 616 can be coupled to GPU 620 via a D2D or C2C interconnect 624. CPU 616 can also couple to GPU 618 and GPU 620 via PCIe interconnects. CPU 616 can be coupled to one or more NICs or DPUs, which are coupled to one or more networks. For example, as illustrated in FIG. 6, CPU 616 is coupled to a first NIC/DPU 632, which is coupled to a network 636. CPU 616 is also coupled to a second NIC/DPU 634, which is coupled to network 636 via switch 650. NIC/DPU 632 and NIC/DPU 634 can be coupled to network 636 over Ethernet (ETH), NVLINK or InfiniBand (IB) connections.

In at least one embodiment, processing device 602 and processing device 604 can communicate with each other via a NIC/DPU 638, such as over PCIe interconnects. Processing device 602 and processing device 604 can also communicate with each other over a high-bandwidth communication interconnect 640, such as an NVLink interconnect or other high-speed interconnects. The packet switches in FIG. 6 may comprise, for example, Nvidia Quantum-2 switches. The NICs/DPUs in the figure may comprise, for example, Nvidia Bluefield DPUs.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A data processing unit (DPU) comprising:
a host interface to receive a generic publish-subscribe (Pub/Sub) call from a host device;
at least one processing core to execute:
an orchestration function to select a specific pub/sub service based on the generic pub/sub call; and
a translation layer to translate the generic pub/sub call to a specific pub/sub call compatible with the selected specific pub/sub service; and
a forwarding interface to provide the translated specific pub/sub call to the selected specific pub/sub service.

2. The DPU according to claim 1, wherein the specific pub/sub service comprises at least one of: a broker-based pub/sub service or a brokerless pub/sub service.

3. The DPU according to claim 1, wherein the generic pub/sub call comprises a publication message or a subscription request.

4. The DPU according to claim 1, wherein the orchestration function is to maintain a mapping between topics and different pub/sub services.

5. The DPU according to claim 4, wherein the orchestration function is to select the specific pub/sub service based on a topic associated with the generic pub/sub call.

6. The DPU according to claim 1, wherein the at least one processing core is to execute para-virtualized pub/sub backends to interface with a para-virtualized pub/sub driver frontend running on the host device.

7. The DPU according to claim 6, wherein the para-virtualized pub/sub backends comprise multiple backend translation functions of the translation layer, each backend translation function corresponding to a different pub/sub service.

8. The DPU according to claim 1, wherein the generic pub/sub call is based on a Remote Direct Memory Operation (RDMO) pub/sub command.

9. The DPU according to claim 8, wherein the orchestration function is to:
receive an RDMO notification from the host device;
read the RDMO pub/sub command from a work queue stored in host memory responsively to receiving the RDMO notification; and
derive the generic pub/sub call from the read RDMO pub/sub command.

10. The DPU according to claim 1, wherein the translation layer includes multiple translation functions to translate generic pub/sub calls to specific pub/sub calls compatible with respective pub/sub services.

11. The DPU according to claim 1, wherein the at least one processing core is to execute a security function to filter or block pub/sub calls based on predefined criteria without notifying the host device.

12. A system comprising:
a host device to generate a generic publish-subscribe (Pub/Sub) call; and
a data processing unit (DPU) coupled to the host device, the DPU comprising:
a host interface to receive the generic pub/sub call from the host;
at least one processing core to execute: an orchestration function to select a specific pub/sub service based on the generic pub/sub call; and a translation layer to translate the generic pub/sub call to a specific pub/sub call compatible with the selected specific pub/sub service; and
a forwarding interface to provide the translated specific pub/sub call to the selected specific pub/sub service.

13. The system according to claim 12, wherein the specific pub/sub service comprises at least one of: a broker-based pub/sub service or a brokerless pub/sub service.

14. The system according to claim 12, wherein the generic pub/sub call comprises a publication message or a subscription request.

15. The system according to claim 12, wherein the orchestration function is to maintain a mapping between topics and different pub/sub services.

16. The system according to claim 15, wherein the orchestration function is to select the specific pub/sub service based on a topic associated with the generic pub/sub call.

17. The system according to claim 12, wherein:
the host is to execute a para-virtualized pub/sub driver frontend; and
the at least one processing core of the DPU is to execute para-virtualized pub/sub backends to interface with the para-virtualized pub/sub driver frontend running on the host device.

18. The system according to claim 17, wherein the para-virtualized pub/sub backends comprise multiple backend translation functions of the translation layer, each backend translation function corresponding to a different pub/sub service.

19. The system according to claim 12, wherein the generic pub/sub call is comprised in a Remote Direct Memory Operation (RDMO) pub/sub command.

20. The system according to claim 19, wherein:
the host device is to:
generate the RDMO pub/sub command;
write the RDMO pub/sub command to a work queue stored in host memory; and
send an RDMO notification to the DPU notifying the DPU that the RDMO pub/sub command is in the work queue; and
the orchestration function is to:
receive the RDMO notification from the host device;
read the RDMO pub/sub command from the work queue responsively to receiving the RDMO notification; and
derive the generic pub/sub call from the read RDMO pub/sub command.

21. The system according to claim 20, wherein the translation layer includes multiple translation functions to translate generic pub/sub calls to specific pub/sub calls compatible with respective pub/sub services.

22. The system according to claim 12, wherein the at least one processing core is to execute a security function to filter or block pub/sub calls based on predefined criteria without notifying the host device.

23. A method, comprising:
receiving a generic publish-subscribe (Pub/Sub) call from a host device;
selecting a specific pub/sub service based on the generic pub/sub call;
translating the generic pub/sub call to a specific pub/sub call compatible with the selected specific pub/sub service; and
providing the translated specific pub/sub call to the selected specific pub/sub service.
